(19) United States
(12) Patent Application Publication
(10) Pub. No.: US 2025/0138857 A1
(43) Pub. Date: May 1, 2025

(54) RELIABLE MULTICAST SUPPORT BETWEEN CO-OPERATING SERVICES USING A CLUSTER EVENT MANAGER

(71) Applicant: Dell Products L.P., Round Rock, TX (US)

(72) Inventors: George Mathew, Belmont, CA (US); Shefali Gautam, Belmont, CA (US)

(21) Appl. No.: 18/497,796

(22) Filed: Oct. 30, 2023

(51) Int. Cl. G06F 9/455

(52) U.S. Cl. CPC G06F 9/45558; G06F 2009/4557

(57) ABSTRACT

A first event sent from a service belonging to a distributed data management application for one or more other services is received. The service and one or more other services are hosted across nodes of the cluster and the service is a sending service. The first event, including a first membership list listing services that are currently members of the cluster, is broadcast to each service in the cluster. A second event is received indicating that a new service belonging to the application has joined the cluster. The second event, including a second membership list listing services that are currently members of the cluster, is broadcast to each service in the cluster. The second membership list includes the new service. The sending service identifies the new service by comparing the first and second membership lists and determines whether the new service should be sent the first event.

### TECHNICAL FIELD

The present invention relates generally to information processing systems, and more particularly to large-scale distributed applications having stateful services.

### BACKGROUND

A stateful application is a type of application that relies on previous events, actions, or data in order to function. There are challenges, however, with providing a stateful application in a distributed system. More particularly, it is difficult to manage and maintain state across multiple nodes for a distributed application. Ensuring consistency and coherency is further complicated when at any given time there may be new nodes coming online or existing nodes going offline.

There is a need for improved systems and techniques to handle large-scale distributed applications having stateful services.

The subject matter discussed in the background section should not be assumed to be prior art merely as a result of its mention in the background section. Similarly, a problem mentioned in the background section or associated with the subject matter of the background section should not be assumed to have been previously recognized in the prior art. The subject matter in the background section merely represents different approaches, which in and of themselves may also be inventions.

### BRIEF DESCRIPTION OF THE FIGURES

In the following drawings like reference numerals designate like structural elements. Although the figures depict various examples, the one or more embodiments and implementations described herein are not limited to the examples depicted in the figures.

FIG. 1 shows a block diagram of an information processing system having a reliable multicast support, according to one or more embodiments.

FIG. 2 shows an example of a deduplication process, according to one or more embodiments.

FIG. 3 shows an example of a namespace, according to one or more embodiments.

FIG. 4 shows a high-level design for reliable multicast support, according to one or more embodiments.

FIG. 5 shows an example of event handling, according to one or more embodiments.

FIG. 6 shows a block diagram of a structure of an event message, according to one or more embodiments.

FIG. 7 shows a flow for reliable multicast support, according to one or more embodiments.

FIG. 8 shows a swimlane diagram of setting a replicated state across a cluster, according to one or more embodiments.

FIG. 9 shows a swimlane diagram of a service leaving a cluster when setting a replicated state across the cluster, according to one or more embodiments.

FIG. 10 shows a swimlane diagram of handling multiple membership changes in a cluster, according to one or more embodiments.

FIG. 11 shows another flow for reliable multicast support, according to one or more embodiments.

FIG. 12 shows a block diagram of a processing platform that may be utilized to implement at least a portion of an information processing system, according to one or more embodiments.

FIG. 13 shows a block diagram of a computer system suitable for use with the system, according to one or more embodiments.

### DETAILED DESCRIPTION

A detailed description of one or more embodiments is provided below along with accompanying figures that illustrate the principles of the described embodiments. While aspects of the invention are described in conjunction with such embodiment(s), it should be understood that it is not limited to any one embodiment. On the contrary, the scope is limited only by the claims and the invention encompasses numerous alternatives, modifications, and equivalents. For the purpose of example, numerous specific details are set forth in the following description in order to provide a thorough understanding of the described embodiments, which may be practiced according to the claims without some or all of these specific details. For the purpose of clarity, technical material that is known in the technical fields related to the embodiments has not been described in detail so that the described embodiments are not unnecessarily obscured.

It should be appreciated that the described embodiments can be implemented in numerous ways, including as a process, an apparatus, a system, a device, a method, or a computer-readable medium such as a computer-readable storage medium containing computer-readable instructions or computer program code, or as a computer program product, comprising a computer-usable medium having a computer-readable program code embodied therein. In the context of this disclosure, a computer-usable medium or computer-readable medium may be any physical medium that can contain or store the program for use by or in connection with the instruction execution system, apparatus or device. For example, the computer-readable storage medium or computer-usable medium may be, but is not limited to, a random access memory (RAM), read-only memory (ROM), or a persistent store, such as a mass storage device, hard drives, CDROM, DVDROM, tape, erasable programmable read-only memory (EPROM or flash memory), or any magnetic, electromagnetic, optical, or electrical means or system, apparatus or device for storing information. Alternatively or additionally, the computer-readable storage medium or computer-usable medium may be any combination of these devices or even paper or another suitable medium upon which the program code is printed, as the program code can be electronically captured, via, for instance, optical scanning of the paper or other medium, then compiled, interpreted, or otherwise processed in a suitable manner, if necessary, and then stored in a computer memory. Applications, software programs or computer-readable instructions may be referred to as components or modules. Applications may be hardwired or hard coded in hardware or take the form of software executing on a general purpose computer or be hardwired or hard coded in hardware such that when the software is loaded into and/or executed by the computer, the computer becomes an apparatus for practicing the invention. Applications may also be downloaded, in whole or in part, through the use of a software development kit or toolkit that enables the creation and implementation of the described embodiments. In this specification, these implementations, or any other form that the invention may take, may be referred to as techniques. In general, the order of the steps of disclosed processes may be altered within the scope of the invention. Aspects of the one or more embodiments described herein may be implemented on one or more computers executing software instructions, and the computers may be networked in a client-server arrangement or similar distributed computer network. Components of the systems described herein may communicate programmatically with each other such as a via application programming interfaces (APIs). In this disclosure, the variable N and other similar index variables are assumed to be arbitrary positive integers greater than or equal to two.

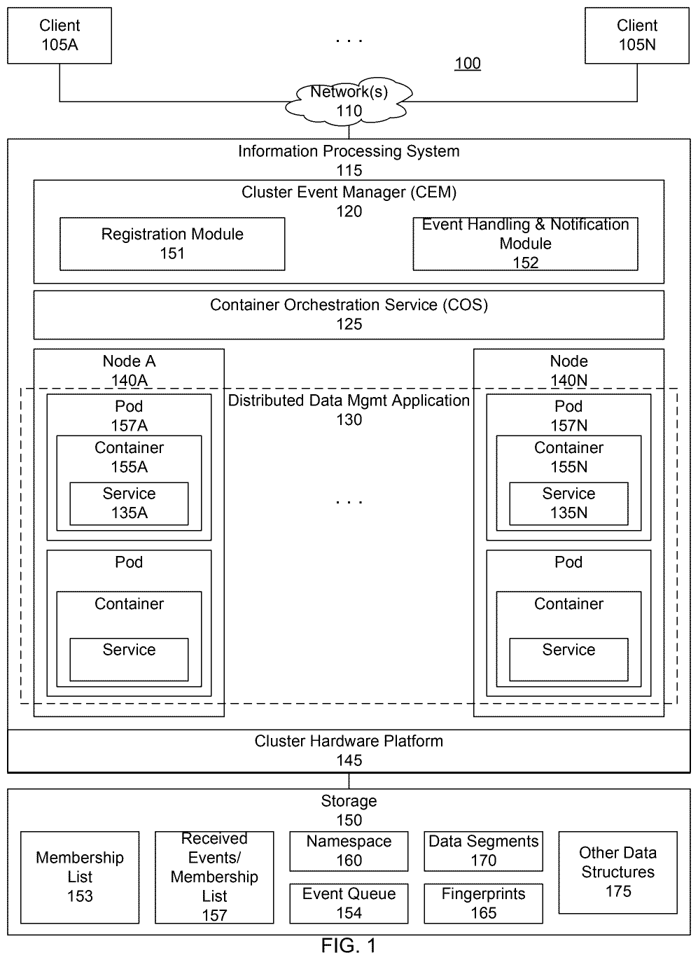

FIG. 1 shows a simplified block diagram of a system 100 within which methods and systems for reliable multicast support between or among co-operating services in a cluster may be implemented. The example shown in FIG. 1 includes a set of clients 105A-N connected via a network 110 to an information processing system 115. The information processing system is responsible for managing and storing data belonging to the clients. In an embodiment, the information processing system includes a cluster event manager (CEM) 120, a container orchestration service (COS) 125, a distributed data management application or distributed system 130 having a set of services 135A-N distributed across nodes 140A-N of a cluster, an underlying cluster hardware platform 145, and a storage system 150. In an embodiment, application services are stateful. That is, they rely on previous events, actions, data, or combinations of these in order to function.

There is a need for the different services and components of the distributed application to communicate with each other in order to synchronize operations, maintain a consistent state and coherent view of data across services, and ensure the reliability and performance of the application. In a cluster of nodes, where application instances (stateful) run as a cluster of services, service membership can change. For example, in an embodiment, the distributed data management application has multiple instances running on nodes of the cluster where each instance runs as a service. In such a cluster of services, if a service is added to the cluster, deleted from the cluster, crashes or goes down, or is restarted, a change in the service membership of the cluster is witnessed.

In an embodiment, systems and techniques are provided for reliable multicast messaging support where: 1) The message is given to one or more services present in the service membership list; 2) The sender service, i.e., the service that posted the message, gets to know a list of services where the message may be delivered; 3) Any change in service membership list may be notified to the sender service; and 4) Sender service can track the set of receiver services even across the service restart.

In an embodiment, the cluster event manager includes a registration module 151 and an event handling and notification module 152. It should be appreciated that the components shown in FIG. 1 and elsewhere can be functional and there can be many different software configurations, hardware configurations, or both to implement the functions described.

The registration module is responsible for handling the registration of services belonging to the distributed application. When a service is registered, the service is assigned a birth generation identifier (e.g., “birth_gen_id”) that identifies a time when the service registered with the cluster event manager. A service registered with the cluster event manager may be referred to as a subscriber.

In an embodiment, the services can be added to the cluster by the container orchestration service. Upon addition to the cluster, the services contact the cluster event manager for registration. The registration module maintains a service membership list 153, persisted to storage, that includes a listing of all services belonging to the distributed application that are currently members in the cluster. The membership list may include a name of a service, a birth generation identifier indicating when the service joined the cluster, and a service type.

The membership list lists the services that are currently active, present, and running in the cluster. For example, when a new service belonging to the distributed application is added to or joins the cluster, the new service registers or subscribes to the cluster event manager and the cluster event manager generates an updated service membership list that includes the new service. When an existing service belonging to the distributed application is removed from or leaves the cluster, the cluster event manager generates an updated service membership list that does not include the existing service.

The event handling and notification module is responsible monitoring events in the cluster, assigning identifiers to the events, organizing the events into a queue 154, and broadcasting messages about the events to each service belonging to the distributed application. In an embodiment, each event is assigned a cluster generation identifier (ID) that uniquely identifies an event and order in which it was received. The events received by the cluster event manager may include both messages concerning changes in membership sent by the container orchestration service and messages posted by a service belonging to the distributed application to be sent to one or more other services of or associated with the distributed application.

In an embodiment, each broadcasted event message includes details about the event and a copy of the service membership list listing the services belonging to the application that are currently members of the cluster. Including the service membership list with each broadcast facilitates, among other things, maintaining a consistent state and coherency across the various services belonging to the application and distributed across the nodes of the cluster.

For example, a service, upon receipt of the event, including the service membership list, from the cluster event manager, persists the event and associated service membership list 157 to storage. As services are added to and removed from the cluster over time, a particular service upon receipt of a current service membership list can compare the current membership list with a previously received and persisted membership list to deduce and identify which services joined the cluster, which services left the cluster, or both. Once the services have been identified, the particular service can determine whether a newly added service should be notified of an operation, whether a lack of reply from a service that has left the cluster can be ignored, or both. Further discussion is provided below.

The network may be a cloud network, local area network (LAN), wide area network (WAN) or other appropriate network. The network provides connectivity to the various systems, components, and resources of the system, and may be implemented using protocols such as Transmission Control Protocol (TCP) and/or Internet Protocol (IP), well-known in the relevant arts. In a distributed network environment, the network may represent a cloud-based network environment in which applications, servers and data are maintained and provided through a centralized cloud computing platform. In an embodiment, the system may represent a multi-tenant network in which a server computer runs a single instance of a program serving multiple clients (tenants) in which the program is designed to virtually partition its data so that each client works with its own customized virtual application, with each virtual machine (VM) representing virtual clients that may be supported by one or more servers within each VM, or other type of centralized network server.

The storage system provides persistent storage for the services. The storage system may include storage servers, clusters of storage servers, network storage device, storage device arrays, storage subsystems including RAID (Redundant Array of Independent Disks) components, a storage area network (SAN), Network-attached Storage (NAS), or Direct-attached Storage (DAS) that make use of large-scale network accessible storage devices, such as large capacity tape or drive (optical or magnetic) arrays, shared storage pool, or an object or cloud storage service. In an embodiment, storage (e.g., tape or disk array) may represent any practical storage device or set of devices, such as tape libraries, virtual tape libraries (VTL), fiber-channel (FC) storage area network devices, and OST (OpenStorage) devices. The storage may include any number of storage arrays having any number of disk arrays organized into logical unit numbers (LUNs). A LUN is a number or other identifier used to identify a logical storage unit. A disk may be configured as a single LUN or may include multiple disks. A LUN may include a portion of a disk, portions of multiple disks, or multiple complete disks. Thus, storage may represent logical storage that includes any number of physical storage devices connected to form a logical storage.

In an embodiment, the distributed data management application is a container-based application where services 135A-N belonging to the application run within containers 155A-N. The services may be referred to as microservices. The nodes are the machines within the cluster that host and run the containers. A container is a virtualized computing environment to run an application program as a service or, more specifically, microservice. The container orchestration service or layer is responsible for managing the deployment, scaling, load balancing, and health of the containers and services. For example, the container orchestration service may add a new instance of a service to accommodate an increase in demand and thus ensure good performance for clients that may be accessing the service. Alternatively, the container orchestration service may remove an existing instance of a service to accommodate a decrease in demand and thus reduce costs associated with resources needed to run the services. The number of instances running the services can change based on demand. An example of a container orchestration service is Kubernetes (K8s). Kubernetes is an open-source container-orchestration system for automating computer application deployment, scaling, and management.

In other words, in an embodiment, the services belonging to the distributed application run inside a virtualized environment provided by the container orchestration service. The container orchestration service can run on a single or multiple physical or virtual nodes. Containers are similar to virtual machines (VMs). Unlike VMs, however, containers have relaxed isolation properties to share the operating system (OS) among the containerized application programs. Containers are thus considered lightweight. Containers can be portable across hardware platforms including clouds because they are decoupled from the underlying infrastructure. Applications are run by containers as microservices with the container orchestration service facilitating scaling and failover. For example, the container orchestration service can restart containers that fail, replace containers, kill containers that fail to respond to health checks, and may withhold advertising them to clients until they are ready to serve.

The nodes may be physical servers or virtual machines. The nodes are responsible for managing the computing resources such as central processing units (CPUs), memory, and storage required for running the containers. One or more containers may be grouped into a group that may be referred to as a pod. Pods 157A-N can run one or more containers that share the same network namespace, storage, and other resources.

In an embodiment, the distributed data management application includes a distributed file system. The file system provides a way to organize data stored in a storage system and present that data to clients or client applications in a logical format. The file system organizes the data into files and folders into which the files may be stored. When a client requests access to a file, the file system issues a file handle or other identifier for the file to the client. The client can use the file handle or other identifier in subsequent operations involving the file. A namespace of the file system provides a hierarchical organizational structure for identifying file system objects through a file path. A file can be identified by its path through a structure of folders and subfolders in the file system. A file system may hold many hundreds of thousands or even many millions of files across many different folders and subfolders and spanning thousands of terabytes.

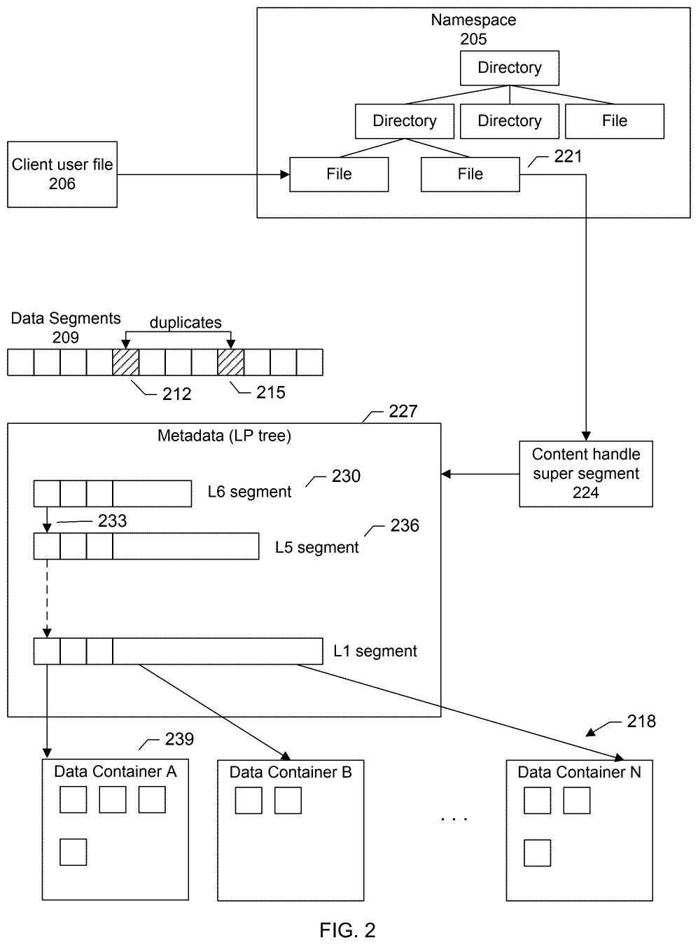

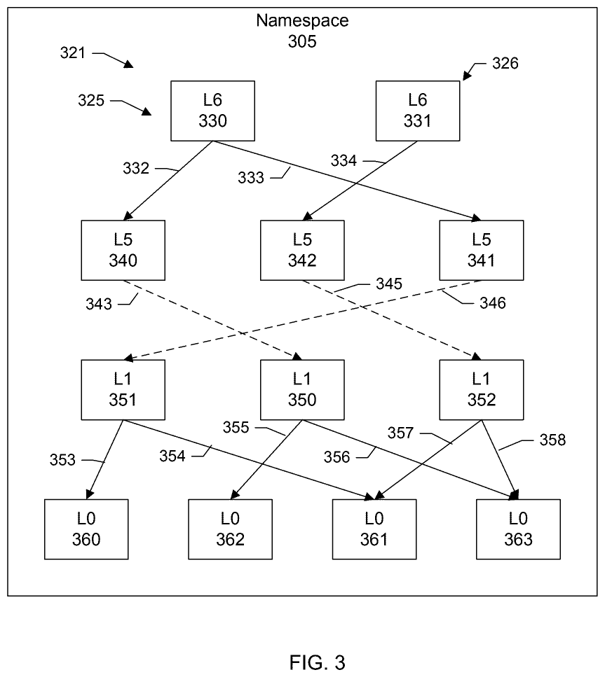

In an embodiment, the file system is a deduplicated file system. The file system may maintain in storage data structures such as a namespace 160, fingerprints 165, data segments 170, and other data structures 175. FIG. 2 shows a block diagram illustrating a deduplication process of the file system according to one or more embodiments. A deduplicated file system is a type of file system that can reduce the amount of redundant data that is stored. As shown in the example of FIG. 2, the file system maintains a namespace 205. Further details of a file system namespace are provided in FIG. 3 and the discussion accompanying FIG. 3.

As data, such as incoming client user file 206, enters the file system, it is segmented into data segments 209 and filtered against existing segments to remove duplicates (e.g., duplicate segments 212, 215). A segment that happens to be the same as another segment that is already stored in the file system may not be again stored. This helps to eliminate redundant data and conserve storage space. Metadata, however, is generated and stored that allows the file system to reconstruct or reassemble the file using the already or previously stored segment. Metadata is different from user data. Metadata may be used to track in the file system the location of the user data within a shared storage pool. The amount of metadata may range from about 2 or 4 percent the size of the user data.

More specifically, the file system maintains among other metadata structures a fingerprint index. The fingerprint index includes a listing of fingerprints corresponding to data segments already stored to the storage pool. A cryptographic hash function (e.g., Secure Hash Algorithm 1 (SHA1)) is applied to segments of the incoming file to calculate the fingerprints (e.g., SHA1 hash values) for each of the data segments making up the incoming file. The fingerprints are compared to the fingerprint index. Matching fingerprints indicate that corresponding data segments are already stored. Non-matching fingerprints indicate that the corresponding data segments are unique and should be stored.

Unique data segments are stored in fixed size immutable containers 218. There can be many millions of containers tracked by the file system. The fingerprint index is updated with the fingerprints corresponding to the newly stored data segments. A content handle 221 of the file is kept in the file system's namespace to support the directory hierarchy. The content handle points to a super segment 224 which holds a reference to a top of a segment tree 227 of the file. The super segment points to a top reference 230 that points 233 to metadata 236 and data segments 239.

In other words, in a specific embodiment, each file in the file system may be represented by a tree. The tree includes a set of segment levels arranged into a hierarchy (e.g., parent-child). Each upper level of the tree includes one or more pointers or references to a lower level of the tree. A last upper level of the tree points to the actual data segments. Thus, upper level segments store metadata while the lowest level segments are the actual data segments. In an embodiment, a segment in an upper level includes a fingerprint (e.g., metadata) of fingerprints of one or more segments in a next lower level (e.g., child level) that the upper level segment references.

A tree may have any number of levels. The number of levels may depend on factors such as the expected size of files that are to be stored, desired deduplication ratio, available resources, overhead, and so forth. In a specific embodiment, there are seven levels L6 to L0. L6 refers to the top level. L6 may be referred to as a root level. L0 refers to the lowest level. Thus, the upper segment levels (from L6 to L1) are the metadata segments and may be referred to as LPs. That is, the L6 to L1 segments include metadata of their respective child segments. The lowest level segments are the data segments and may be referred to as L0s or leaf nodes.

In other words, in an embodiment, every segment in the file system is identified by a 24 byte key (or the fingerprint of the segment), including the LP segments. Each LP segment contains references to lower level LP segments.

FIG. 3 shows further detail of a namespace 305 of the file system that may be used to organize the client data stored in the storage. The namespace includes a set of trees 321 where each file in the file system is represented by a tree. A tree includes a set of segment levels arranged in a hierarchy. In a specific embodiment, a tree can have up to seven levels that may be labeled L6 to L0. For example, one or more intermediate levels may not be present for a relatively small file. A relatively small file may have, in addition to an L0 segment, just an L6 and L1 segment. A relatively large file may have, in addition to an L0 segment, an L6, L5, L4, L3, L2, and L1 segment.

Segments from L6 to L1 are upper level segments that store metadata (e.g., fingerprints) and may be referred to as LP segments. The lowest level segments are the L0 segments which represent actual data content of the file. An upper level segment references one or more lower level segments. Thus, an L6 segment includes an array of L5 references. An L5 segment includes an array of L4 references. An L4 segment includes an array of L3 references. An L3 segment includes an array of L2 references. An L2 segment includes an array of L1 references. An L1 segment includes an array of L0 references. In other words, lower level segments are referenced by higher level segments.

The example shown in FIG. 3 shows segment levels L6, L5, L1, and L0. Segment levels L4, L3, and L2 have been omitted for purposes of clarity. An L6 segment forms a root or parent. Thus, in the example shown in FIG. 3, there is a first tree 325 having an L6 segment 330 and representing a first file. There is a second tree 326 having an L6 segment 331 and representing a second file.

Two or more files may share a same segment. A lower level segment may be referenced by one or more upper level segments. For example, a lower level segment may be referenced by a first upper level segment, and a second upper level segment. The first upper level segment may be from a first tree representing a first file. The second upper level segment may be from a second tree representing a second file. An upper level segment may reference one or more lower level segments. For example, an upper level segment may reference a first lower level segment and a second lower level segment.

In the example shown in FIG. 3, L6 segment 330 references L5 segments 340, 341 as shown by arrows 332, 333 from L6 330 to L5 340, 341, respectively. L6 segment 331 references L5 segment 342 as shown by an arrow 334 from L6 331 to L5 342. L5 segment 340 references an L1 segment 350 as shown by an arrow 343 from L5 340 to L1 350. L5 segment 342 references L1 segments 351, segment 352 as shown by arrows 344, arrow 345 from L5 342 to L1 351, 352, respectively. L5 segment 341 references L1 segment 351 as shown by an arrow 346 from L5 341 to L1 351. The arrows from the L5 to L1 segment level are shown in broken lines to indicate that there can be other intermediate levels between the L5 and L1 levels.

L1 segment 351 references L0 segments 360, 361 as shown by arrows 353, 354 from L1 351 to L0 360, 361, respectively. L1 segment 350 references L0 segments 362, 363 as shown by arrows 355, 356 from L1 350 to L0 362, 363, respectively. L1 segment 352 references L0 segments 361, 363 as shown by arrow 357, 358 from L1 352 to L0 361, 363, respectively.

In a specific embodiment, an upper level segment includes a fingerprint of fingerprints of one or more lower level segments referenced by the upper level segment. For example, L6 segment 330 includes a finger of fingerprints of L5 segments 340, 341. L6 segment 332 includes a fingerprint of fingerprint of L5 segment 342. L5 segment 340 includes a fingerprint of fingerprint of L1 segment 350. L5 segment 342 includes a fingerprint of fingerprints of L1 segments 351, 352, and so forth.

Referring back now to FIG. 1, the cluster event manager is responsible for monitoring the cluster for events. In an embodiment, the cluster event manager receives both event messages from the container orchestration service concerning changes in service membership and event messages from other application services for broadcast. The container orchestration service is separate from the cluster event manager and from the services belonging to the distributed application. For example, the container orchestration service and cluster event manager may be provided by different vendors. The container orchestration service may operate in a layer outside of or above that of the nodes that are hosting the services belonging to the distributed data management application such as in a control or management plane.

Event messages posted to the cluster event manager from the application services may be referred to as custom events or application-specific events. Event messages sent by the container orchestration service regarding membership changes in the cluster may be referred to as membership events. In an embodiment, the cluster event manager assigns the same numbering or identification scheme to both types of event messages—i.e., event messages from the container orchestration service and event messages posted by a service belonging to the distributed data management application—and organizes both types of event messages into a single queue or single sequence.

This common or global ordering and numbering scheme helps to facilitate an orderly and sequential or linear processing of events by the services distributed across the nodes of the cluster. The cluster event manager tracks both membership events (e.g., existing service down or new service added) and custom events posted by other services belonging to the application. Events can be ordered with respect to cluster reconfigurations. Events can be processed in chronological or sequential order, i.e., in the order received, regardless of whether the event concerns a change in membership from the container orchestration service or a request posted by a service of the application for one or more other services of the application. Services processing different events at different time frames can be avoided thereby facilitating consistency of state and coherency in the cluster. The queue provides a buffering of events to help manage spikes in the number of event notifications and smooth demands on resources. Consider, as an example, ten events to be processed. Rather than a first service processing a tenth event while a second service is processing a second event, systems and techniques are provided to help ensure a service does not move on to processing a next event unless other relevant services have finished processing a current event.

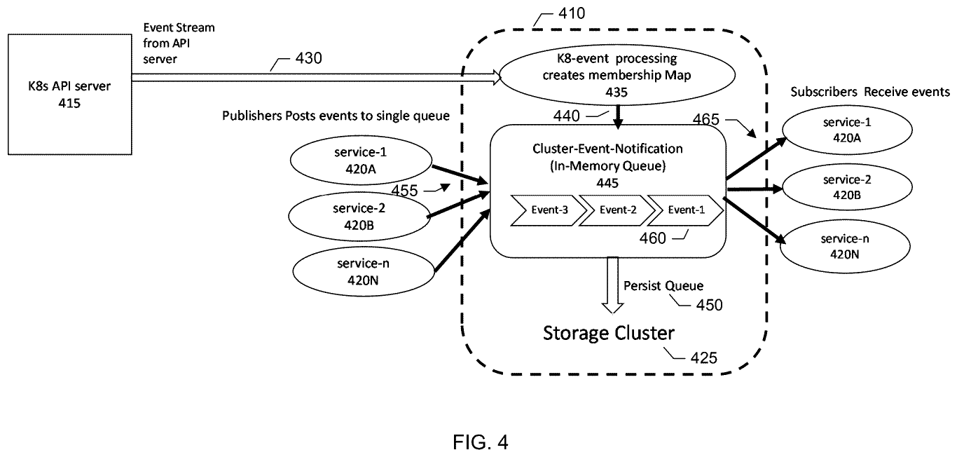

FIG. 4 shows a block diagram of cluster event manager operations. The example shown in FIG. 4, includes a cluster event manager 410, container orchestration service (e.g., K8s API server) 415, distributed application services 420A-N, and persistent storage 425. The services may be referred to as clients of the cluster event manager.

In a step 430, the cluster event manager receives an event stream from the container orchestration service. The cluster event manager watches the container orchestration service for membership change. The event stream includes events about changes in service membership (e.g., services added to cluster or services removed from the cluster).

In a step 435, the cluster event manager processes the received events about changes in service membership and creates a membership map listing the services presently or currently available in the cluster. In a step 440, the cluster event manager adds each event concerning membership change to a queue 445. The events can be added to the queue in the order received. For example, upon receipt of a first event, the first event is added to the queue. Upon receipt of a second event, after the first event, the second event is added to an end or tail of the queue. Upon receipt of a third event, after the first and second events, the third event is added to the end or tail of the queue, and so forth. In a step 450, the queue is additionally persisted to storage to facilitate high-availability.

Changes in service membership may occur in conjunction with the various services belonging to the distributed application publishing or posting 455 events for one or more other services belonging to the distributed application. Such events are also received by the cluster event manager and placed into the same single queue 445 holding events about membership changes. In a step 460, the cluster event manager retrieves or fetches an event from a head or front of the queue and broadcasts 465 the event to each service belonging to the distributed application-including the service that initially posted the event. As discussed, each event that is broadcasted by the cluster event manager includes a copy of the membership list listing the services that are currently present in the cluster at the time of broadcast. A service that posts an event may be referred to as a publisher or sending service. A service that receives an event may be referred to as a subscriber or receiving service.

Consider, as an example, that first service 420A posts a first event to the cluster event manager. The cluster event manager adds the first event to the queue and subsequently broadcasts the first event, including a copy of the service membership list listing the services currently present in the cluster, to each service of the cluster. Thus, first service 420A (along with each of remaining services 420B-N) receives the first event and the copy of the service membership list and persists the first event including the copy of the service membership list to storage.

The receipt of the service membership list allows the first service to review the services listed in the membership list and identify and track those services that received the first event. The first service is thus made aware of which other services have been sent the first event. In turn, the first service can wait for a reply or acknowledgement to the first event from each of at least a subset of the services that should be interested in the first event. That is, the first service can withhold processing of other operations that may introduce an inconsistent state until each of the at least subset of the services that should be interested in the first event return a reply to the first service concerning a successful receipt or processing of the first event.

The inclusion of the membership list with each broadcasted event further allows the first service to identify any newly added service to the cluster or any existing services removed from the cluster. Consider, as an example, that the cluster event manager broadcasts a second event, after the first event, about a change in cluster membership where a particular service has joined the cluster. As discussed, the broadcasting of the second event includes an updated copy of the service membership list which then lists the particular service. First service 420A can conduct a diffing or comparison operation of the updated membership list (which includes the particular service) and a previously received and persisted membership list (which does not include the particular service) to deduce and identify the particular service and determine whether the particular service should also be sent the first event. If the particular service should also be sent the first event, the first service can then repost the first event to the cluster event manager. The reposting allows the cluster event manager to again broadcast the first event so that the first event can now be received by the newly joined particular service.

Alternatively, consider as an example, that the second event is about a particular service having left the cluster. As discussed, the broadcasting of the second event includes an updated copy of the service membership list which does not list the particular service. First service 420A can conduct a diffing or comparison of the updated membership list (which does not include the particular service) and a previously received membership list (which does include the particular service) to deduce and identify the particular service and thus determine that the particular service is no longer a member of the cluster. The first service can then skip waiting for a reply to the first event from the particular service and move on to processing other operations. Skipping the reply helps to ensure that the first service does not hang or become stuck in an idle state.

In an embodiment, the cluster event manager is a service running in the cluster. The cluster event manager maintains one or a single queue for all subscribers/clients. The cluster event manager tags each event message with a unique generation-ID. The cluster event manager persists the queue in a storage system for high-availability (HA). A subscriber service can post as well as receive events. There can be a priority-ID associated with every event-callback function on the client-side.

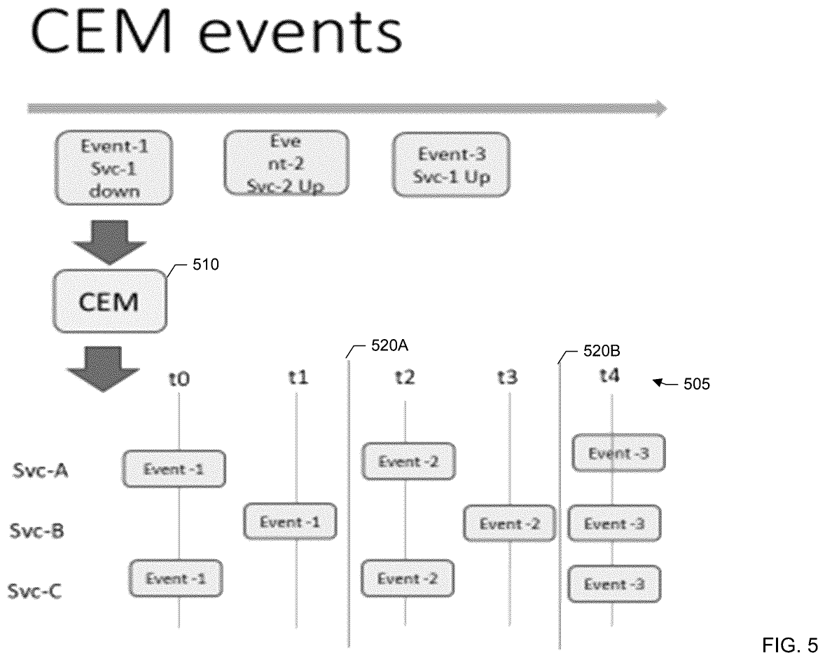

FIG. 5 shows a timeline 505 of event handling facilitated by a cluster event manager 510. As shown in the example of FIG. 5, between a time t0-t1, a service A, service B, and service C consume event-1. Between a time t1-t3, service A, service B, and service C consume event-2. After a time t3, service A, service B, and service C consume event-3.

In an embodiment, services watch for events via the cluster event manager. The cluster event manager maintains a single queue. Global ordering can be guaranteed. Hierarchical processing can be guaranteed. A barrier sync 520A,B between multiple events can be guaranteed. All subscribers process event (n) before processing event (n+1).

More specifically, the cluster event manager helps to ensure that a service does not consume an event out of order and a service does not consume a next event before other services have consumed a current event. For example, although services A and C have processed event-1 at time t0, services A and C wait or pause and do not advance to processing event-2 at time t1 because service B has yet to process event-1 as of time t0. That is, services A and C wait until service B has processed event-1 at time t1 before advancing to process event-2 at time t2. Likewise, although services A and C have processed event-2 at time t2, services A and C wait and do not advance to process event-3 at time t3 because service B has yet to process event-2 as of time t2. That is, services A and C wait until service B has processed event-2 at time t3 before advancing to process event-3 at time t4.

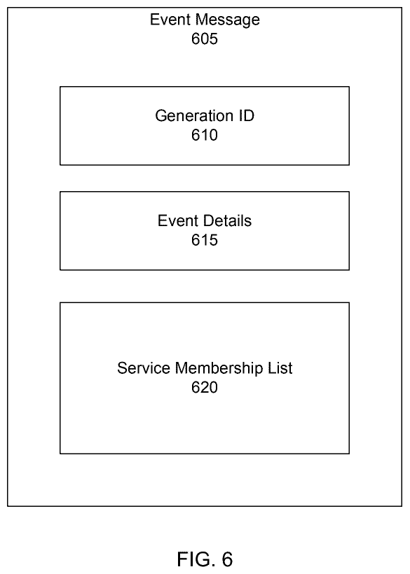

FIG. 6 shows an example of a structure for an event message 605 that may be broadcast or sent by the cluster event manager. The structure includes a generation identifier (ID) 610, event details 615, and service membership list 620.

The generation identifier is a value that uniquely identifies an event. The event may correspond to a change in cluster membership as detected by the cluster orchestration service. Alternatively, the event may correspond to an event posted by a service belonging to the distributed application for one or more other services belonging to the distributed application.

The event details section includes information about the event such as the type of event, operation performed by the event poster, operation requested to be performed by the event subscriber, or other notification.

The service membership list includes a listing of the services belonging to the distributed application that are currently in the cluster. The listing may include a name of the service, identifier assigned to the service indicating when the service joined the cluster (e.g., birth generation identifier), type of service, other descriptor associated with the service, or combinations of these.

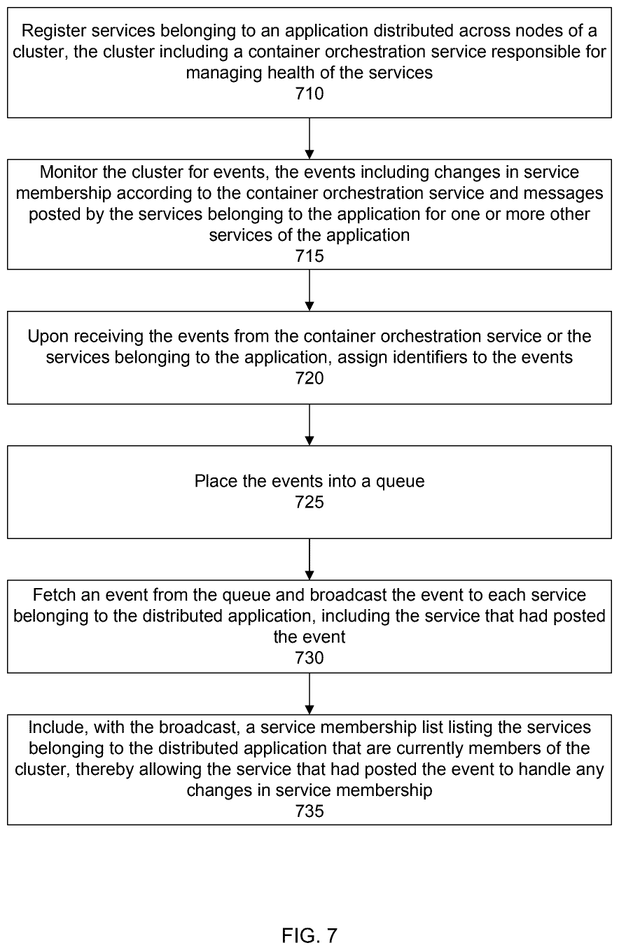

FIG. 7 shows an overall flow for reliable multicast support. Some specific flows are presented in this application, but it should be understood that the process is not limited to the specific flows and steps presented. For example, a flow may have additional steps (not necessarily described in this application), different steps which replace some of the steps presented, fewer steps or a subset of the steps presented, or steps in a different order than presented, or any combination of these. Further, the steps in other embodiments may not be exactly the same as the steps presented and may be modified or altered as appropriate for a particular process, application or based on the data.

In brief, in a step 710, services belonging to a distributed application hosted in a cluster are registered to a cluster event manager. The cluster includes a container orchestration service, separate from the cluster event manager, that is responsible for managing health of the services.

In a step 715, the cluster is monitored for events. The monitored events include changes in service membership according to the container orchestration service and messages posted by the services belonging to the distributed application for one or more other services belonging to the distributed application.

In a step 720, upon receiving events from the container orchestration service, the services belonging to the distributed application, or both, identifiers are assigned to the events. In a step 725, the events are placed or inserted into a queue.

In a step 730, an event is fetched from the queue (e.g., from a head of the queue) and the event is broadcast to each service belonging to the application. In a step 735, included with each event broadcast is a service membership list listing the services belonging to the application that are currently members of the cluster at the time of broadcast. Thus, as an example, a service belonging to the application that posted an event to the cluster event manager also receives as part of the event broadcast by the cluster event manager the service membership list. The service, upon receipt of the event broadcast, persists the event including the service membership list.

More particularly, in an embodiment, the cluster event manager generates an ordered reliable event queue on top of a container orchestration service. The cluster event manager keeps track of the membership of services registered to CEM and maintains a service membership list. CEM keeps a cluster generation ID that is bumped up, e.g., incremented, every time there is a change in membership.

When a new service registers to CEM, the cluster generation ID is bumped up, e.g., incremented. In another embodiment, identifiers are generated based on decrementing a last identifier value. It should be appreciated that an algorithm to generate identifiers may include any mathematical computation or operation so long as it generates an ordered or sequential listing of unique values. In an embodiment, the service membership list is updated where, a tuple <service_name, birth_gen_id, service_type> is added to the list. The birth_gen_id is the cluster generation ID at which the service joined/registered. A membership change event is created with the latest membership information. That is, a service add event is generated that has all the services with their birth_gen_ids. The service add event is then published to all the services registered to CEM at the time of event generation.

The newly registered service also gets the event and the service membership list. This makes it is possible for the service to find out all other services that had registered with CEM and at what generation ID they had registered.

A death of a service can generate a service-down event that bumps up, e.g., increments, the cluster generation ID and the corresponding service may be removed from the service membership list in CEM.

This event may also be sent to all services that had registered to CEM. By looking at the received event and the included service membership list, it is possible for the registered services to find the service that was removed from the list.

CEM also allows custom events. As discussed, custom events refer to events created by the applications or application services registered to CEM. Such events can be generated and queued in CEM. Like membership events, custom events also contain the service membership list and may be sent to all the services registered to CEM. The custom event is also delivered to the service that posted the event. The properties described above can be used to create a multicast mechanism that can be used for operations including setting a replicated state among a subset or set of services, sending an event to a set of services and managing replies expected from the services that received the event, and handling a restart of the service that posted the event, among other operations.

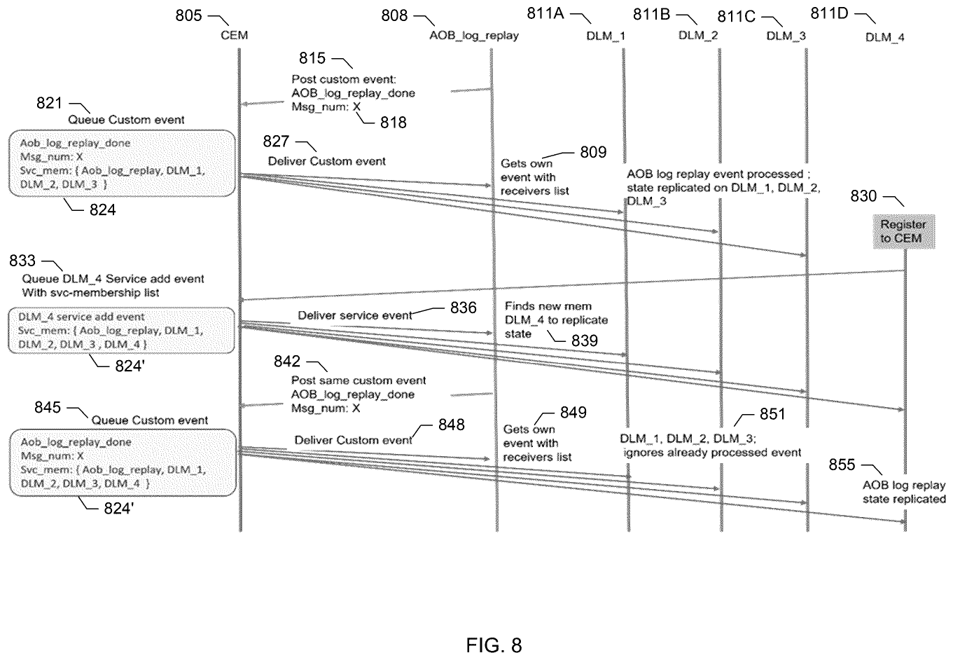

FIG. 8 shows a swimlane diagram for setting up a replicated state across services belonging to the distributed application. Each service is brought to the same state. Entities in the swimlane diagram include CEM 805, posting or sending service 808 (e.g., “AoB_log_replay”), and first, second, third, and fourth receiving or consuming services (e.g., “DLM_1-4”) 811A-D, respectively.

In an embodiment, a distributed application or file system relies on a log or journal to maintain integrity and consistency of application or file system data. Changes or transactions related to application operations are recorded in the log. Log replay operations involve examining a sequential record of operations or transactions stored in a log and applying those operations to recreate the state of the system. Services that may rely on state include a distributed lock manager (DLM) service. The DLM service is responsible for managing and coordinating access to files and resources to prevent conflicts and maintain data consistency. The DLM service helps to ensure that concurrent access to files by multiple clients is controlled and that operations are performed in a safe and orderly manner. In an embodiment, systems and techniques are provided to ensure that operations, such as log replay, are reliably, consistently, and evenly applied across multiple nodes or services in the cluster, despite on-going events in the cluster such as changes in service membership.

In an embodiment, a service can post a custom event to CEM where, the custom event describes an event type and includes a unique message number. All services registered with CEM can receive the custom event but it may be the case that only a few interested services may consume it. Other services that receive the event can discard or ignore the event as it is not interesting or relevant to them.

Consider, as an example, that in a cluster multiple co-operating services are running like AOB_log_replay, DLM (distributed lock manager), Key_value_store, Network_mgmt service, or others. When the “AOB_log_replay” service posts a custom event, e.g., “AOB_LOG_REPLAY_DONE”, all services receive it, but the event may only be consumed by the DLM services and discarded by the rest.

Since the service that posted the custom event also gets it, the received event message structure includes the service membership list and using this, the service that posted the event can identify the list of services that will process the event. In this example, the AoB_log_replay service knows how many or which DLM services received the event.

As new services join the cluster, a service-add event can be generated and published to all registered services. If the sender service, i.e., service that posted a custom event earlier, sees a new service that had joined/registered and the state is to be replicated in that, it could post the previous event with the same unique message number. Services that already received the previous event can discard the new event as the message number did not change. Newly registered/joined service can process the event message and set the corresponding state.

In this example, if a new DLM service joined the cluster, the AoB_log_replay service can repost the event message with the same message number. Existing DLM services can discard the event message as the message number did not change but the new DLM service can process it.

More particularly, in this example, consider that at an initial time only posting service 808 (“AOB_log_replay”) and first, second, and third consuming services 811A-C (“DLM_1-3”) are registered with CEM while the fourth consuming service 811D (“DLM_4”) is not registered with CEM. In other words, the first, second, and third consuming services are current members of the cluster and the fourth consuming service is not a current member of the cluster.

In a step 815, the posting service posts a (custom) event to CEM. The event is accompanied by an event message number (e.g., Msg_num: X) 818. In a step 821, CEM queues the event for broadcast. As part of the broadcast, CEM associates a service membership list 824 with the event. As discussed, the service membership list lists the services that are current members of the cluster, e.g., posting service 808 (e.g., “AoB_log_replay”), and first, second, and third consuming services (e.g., “DLM_1-3”) 811A-C, respectively. The fourth consuming service (e.g., “DLM_4”) is not listed in the service membership list because it has not yet registered with CEM and is thus not a current member of the cluster.

In a step 827, CEM delivers or broadcasts the event to each service in the cluster including posting service 808. Thus, each service, including posting service 808, receives 809 the event along with a copy of the membership list listing all the services currently in the cluster that are to receive the event. The services, including posting service 808, persist the event including the membership list. First, second, and third services 811A-C log the event including message number (e.g., Msg_num: X) and process the event.

In a step 830, at a later time after first, second, and third services 811A-C have received or processed the event, fourth service 811D (e.g., “DLM_4”) joins the cluster and registers to CEM. The addition of fourth service 811D to the cluster triggers a membership change event to be generated by the cluster orchestration service and sent to CEM.

In a step 833, CEM queues an add service event for fourth service 811D and updates the service membership list to now include fourth service 811D (e.g., “DLM_4”) as a current member of the cluster. Thus, updated membership list 824′ includes posting service 808 (e.g., “AoB_log_replay”), and first, second, third, and now fourth consuming services (e.g., “DLM_1-4”) 811A-D, respectively.

In a step 836, CEM delivers or broadcasts the service add event concerning the addition of fourth service 811D (e.g., “DLM_4”) to the cluster to each service in the cluster. The updated service membership list is included with the broadcast of the service add event.

In a step 839, posting service 808 (e.g., “AoB_log_replay”) receives the event along with updated service membership list 824′. The posting service compares previously received service membership list 824 with updated service membership list 824′ to identify any differences in the listing. A service present in the updated service membership list, but not present in the previous service membership list, indicates a newly added service. In this example, posting service 808 (e.g., “AoB_log_replay”) identifies from the comparison that fourth service 811D (e.g., “DLM_4”) as being a newly added service that should also consume or process the custom event posted by posting service 808 in step 815.

In other words, posting service 808 can deduce that fourth service 811D is a newly added service because fourth service 811D was absent from a previous service membership list corresponding to a time when the custom event was initially posted, but is now present in an updated service membership list that was received after the custom event was posted. Upon identifying the newly added service, posting service 808 can determine whether the newly added service is a type of service that should be interested in the custom event about state replication. In this example, posting service 808 determines that replicating state is relevant to the new service.

Thus, in a step 842, posting service 808 (e.g., “AoB_log_replay”) reposts the same custom event with the same event message number (e.g., Msg_num: X) to CEM.

In a step 845, CEM again queues the custom event for broadcast and associates updated service membership list 824′ with the reposted event.

In a step 848, CEM delivers or broadcasts the custom event with updated service membership list to each service in the cluster. In other words, the event associated with “Msg_num: X”, including updated service membership list 824′ is received 849 by posting service 808 (e.g., “AoB_log_replay”) and first, second, third, and fourth consuming services (e.g., “DLM_1-4”) 811A-D, respectively.

In a step 851, first, second, and third consuming services (e.g., “DLM_1-3”) 811A-C, respectively, examine the message number (e.g., Msg_num: X) and identify the associated event as having already been processed because the message number just received is the same as the message number previously or initially received in step 827. First, second, and third consuming services (e.g., “DLM_1-3”) 811A-C, respectively, can thus ignore the event.

In a step 855, fourth consuming service (e.g., “DLM_4”) does not have a log indicating an event with message number “X” as having been processed. Fourth consuming service (e.g., “DLM_4”) processes the event. Thus, each of first, second, third, and fourth consuming services (e.g., “DLM_1-4”) 811A-D, respectively, have now processed the custom event posted by posting service 808 (e.g., “AoB_log_replay”) and the services are now brought to a consistent state or same replicated state despite fourth consuming service (e.g., “DLM_4”) 811D having joined the cluster after first, second, and third consuming services (e.g., “DLM_1-3”) 811A-C had received and processed the custom event concerning state replication.

In an embodiment, a method includes: posting a first event to a cluster event manager for the cluster event manager to broadcast the first event to a plurality of services in a cluster; receiving, from the cluster event manager, the first event and a service membership list listing each of the plurality services in the cluster, wherein after the receiving the copy of the first event and service membership list from the cluster event manager, the cluster event manager receives an indication that a new service has joined the cluster; persisting the first event including the service membership list; after the receiving the first event, receiving, from the cluster event manager, a second event about the new service and an updated service membership list, the service membership list now being a previous service membership list; comparing the updated service membership list with the previous service membership list; identifying, from the comparison, the new service because the new service is listed in the updated service membership list, but is not listed in the previous service membership list; and reposting the first event to the cluster event manager for the cluster event manager to broadcast the first event to the plurality of services in the cluster, the plurality of services now including the new service.

In another embodiment, a method includes: receiving a first event from a service of a plurality of services in a cluster to broadcast, the service being a posting service; broadcasting the first event to each service of the plurality of services including the posting service; including, with the broadcasting of the first event, a service membership list listing each service of the plurality of services; after the broadcasting the first event, receiving a second event from a container orchestration service indicating that a new service has joined the cluster; broadcasting the second event to each service of the plurality of services including the posting service; and including, with the broadcasting of the second event, an updated service membership list listing each service of the plurality of services, the updated service membership list including the new service.

In another embodiment, a method includes: receiving a first event sent from a service belonging to a distributed application for one or more other services belonging to the application, the application being hosted across nodes of a cluster, and the service being a sending service; inserting the first event into a queue; prior to broadcasting the first event, associating a service membership list to the first event, the service membership list listing each service belonging to the distributed application that is currently present in the cluster; and broadcasting the first event, with the service membership list, to each service belonging to the distributed application, including the sending service.

In another embodiment, a method includes: receiving, from a cluster event manager, an event to process, the event comprising a message number; processing the first event; after the processing the first event, receiving, from the cluster event manager, another event to process, the other event comprising another message number; comparing the message number and other event message number; determining that the event and other events are the same because the message number and other event message number are the same; and ignoring processing the other event because the event has already been processed.

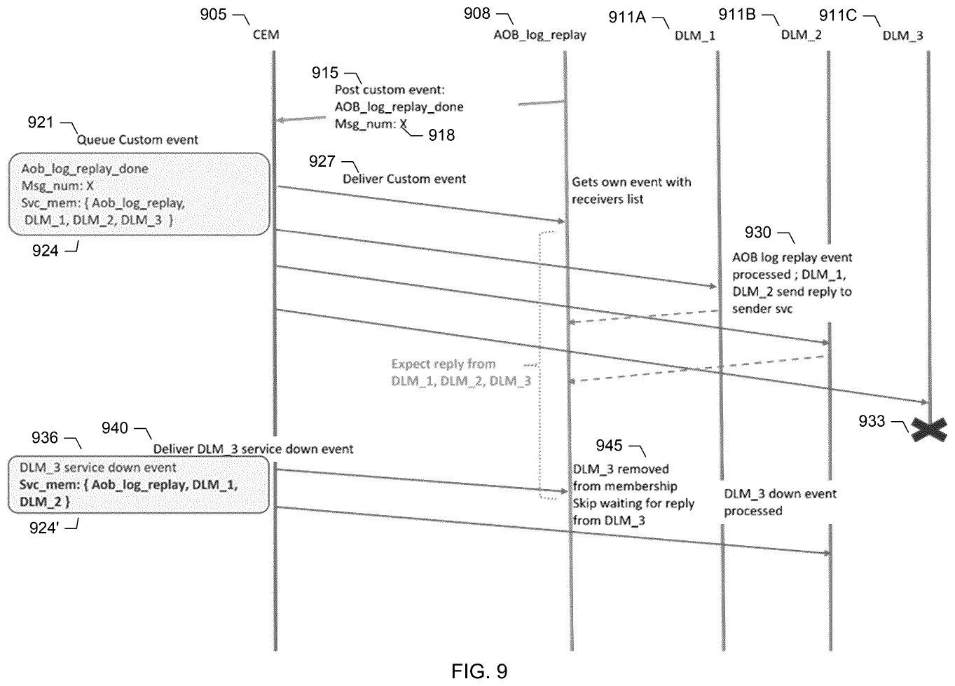

FIG. 9 shows a swimlane diagram for handling a case where an event is sent to a set of services, replies to the event are expected, but at least one of the services fails to reply. Entities in the swimlane diagram include CEM 905, posting or sending service 908 (e.g., “AoB_log_replay”), and first, second, and third receiving or consuming services (e.g., “DLM_1-3”) 911A-C, respectively.

In this case, the service that posted the event, i.e., sender service, is able to identify the list of services receiving the event. Based on this, the sender service may expect a reply or acknowledgement from the services consuming the event.

If any service that received the event, but crashed before sending the reply, the sender service can exclude it from the list of services therefore, not waiting for the crashed service to respond.

Since the service that posts any event also receives the event with the service-membership-list with the information: {Service-Name, Service_Type, Birth-gen_ID}, it knows the list of services expected to send a reply. If any of the services crashed before replying, a CEM service-down event can be delivered to all the registered services. Once the sender service, sees a service down event for the service it was expecting a reply from, it can skip waiting and move on.

For example, when the service “AoB_log_replay” posts a custom event “AOB_LOG_REPLAY_DONE”, all registered members including the sender service “AOB_log_replay” may receive the event with service membership list from CEM. Based on that, AOB_log_replay service can expect a reply from all the DLM_< >services present in the membership list, e.g., “DLM_1, DLM_2, DLM_3” existed in the service membership list when AoB_log_replay service got its own custom event. AOB_log_replay can wait for a reply from DLM_1. DLM_2 and DLM_3. But before DLM_3 could send a reply to AOB_log_replay, it crashed. AoB_log_replay service can know about the death of DLM_3 when CEM delivers DLM_3 service down and, it can skip waiting for a reply from DLM_3 and just wait for replies from DLM_1 and DLM_2. Since custom events and membership events are ordered on a single queue in CEM, there is no need to worry about races between these events.

More particularly, in this example, consider that at an initial time posting service 908 (“AOB_log_replay”) and first, second, and third consuming services 911A-C (“DLM_1-3”) are registered with CEM. In other words, the first, second, and third consuming services are current members of the cluster.

In a step 915, the posting service posts a custom event to CEM. The event is accompanied by an event message number (e.g., Msg_num: X) 918. In a step 921, CEM queues the event for broadcast. CEM associates a membership list 924 with the event. As discussed, the membership list lists the services that are current members of the cluster, e.g., posting service 908 (e.g., “AoB_log_replay”), and first, second, and third consuming services (e.g., “DLM_1-3”) 811A-C, respectively.

In a step 927, CEM delivers or broadcasts the custom event to each service in the cluster including posting service 908. Thus, each service, including posting service 908, receives the event along with a copy of the membership list listing all the services currently in the cluster that are to receive the event. The posting service, having received a copy of the membership list, is now aware that the event has been sent to first, second, and third services 911A-C. The posting service can then enter a state of waiting for a reply from each of the first, second, and third services upon successful processing or receipt of the event.

The services, including posting service 908, persist the received event including the membership list. First, second, and third services 911A-C log the event including message number (e.g., Msg_num: X) and begin to process the event. In this example, first and second services complete the processing of the event and send a reply to posting service 908 upon completion (step 930).

In a step 933, third service 911C crashes, e.g., leaves the cluster, before completing the processing of the event and thus cannot send a reply to the posting service. Meanwhile, the posting service continues to wait for a reply from third service 911C. The crashing of third service 911C, however, triggers the container orchestration service to generate a service down event that is sent to CEM.

In a step 936, CEM generates an updated service membership list 924′ that includes the services currently present in the cluster (e.g., posting service 908 (“AOB_log_replay”) and first and second consuming services 911A-B (“DLM_1-2”). Third consuming service 911C is not included in the updated service membership list because it is now no longer a member of the cluster.

In a step 940, CEM broadcasts or delivers the service down event to each service in the cluster including posting service 908. Included with the broadcast of the service down event is the updated service membership list.

In a step 945, posting service 908 receives the service down event along with updated service membership list 924′. The posting service compares previously received service membership list 924 with updated service membership list 924′ to identify any differences in the listing. A service not present in the updated service membership list, but present in the previously received service membership list, indicates a service that has been removed from the cluster. In this example, posting service 908 (e.g., “AoB_log_replay”) identifies from the comparison that third service 911C (e.g., “DLM_3”) as an existing service that has left the cluster. As a result, posting service 908 can skip waiting for a reply from third consuming service 911C (“DLM_3”) and move on to other operations. In other words, posting service 908 can deduce that third consuming service 911C (“DLM_3”) is no longer in the cluster because third consuming service 911C (“DLM_3”) was present in a previous service membership list corresponding to a time when the custom event was initially posted, but is not present in an updated service membership list that was received after the custom event was posted.

In an embodiment, a method includes: posting a first event to a cluster event manager for the cluster event manager to broadcast the first event to a plurality of services in a cluster; receiving, from the cluster event manager, the first event and a service membership list listing each of the plurality of services in the cluster; waiting for at least a subset of services listed in the service membership list to send replies indicating that the first event has been processed, wherein during the waiting, the cluster event manager receives an indication that at least one service in the at least subset of services has crashed; after the receiving the first event, receiving, from the cluster event manager, a second event about the at least one service crashing and an updated service membership list, the service membership list now being a previous service membership list; comparing the updated service membership list with the previous service membership list; identifying, from the comparison, the at least one service that has crashed because the at least one service is listed in the previous service membership list, but is not listed in the updated service membership list; and skipping waiting for a reply from the at least one service that has crashed.

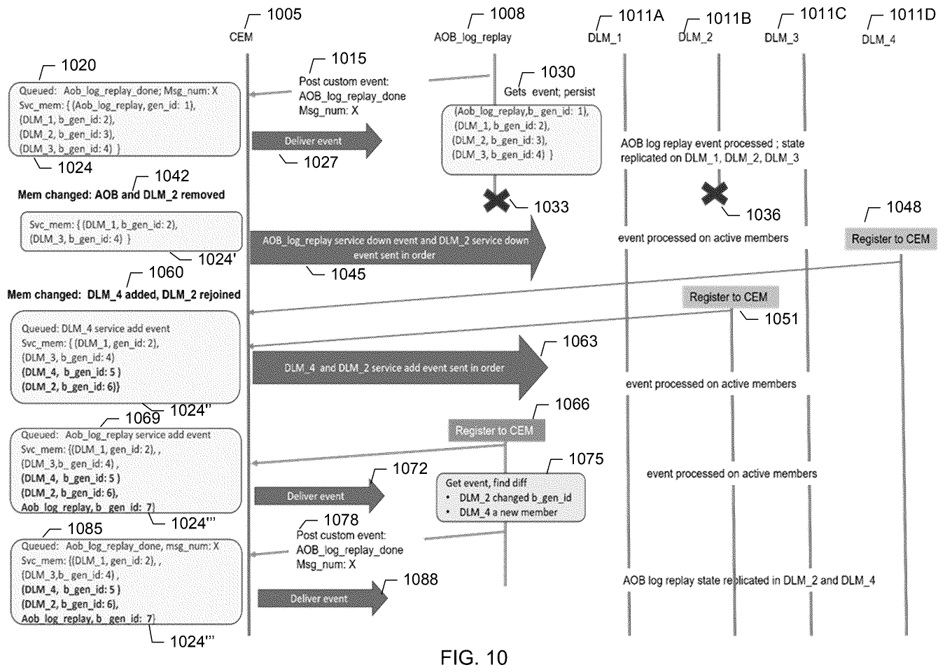

FIG. 10 shows a swimlane diagram for handling a case where the posting service itself crashes and is restarted. Entities in the swimlane diagram include CEM 1005, posting or sending service 1008 (e.g., “AoB_log_replay”), and first, second, third, and fourth receiving or consuming services (e.g., “DLM_1-4”) 1011A-D, respectively.

In this case, a service that posted a custom event to set a replicated state in other services can itself crash. Before it can restart and join CEM, the service membership in the cluster can further change as some existing services can go down and restart or new services can get added. If the sender service persists the last received “service membership list with corresponding cluster-generation-IDs” from CEM, it can identify the membership changes that happened between crash and re-registration by comparing the two:
A) Last received “service membership list with associated birth-generation-IDs” received from CEM before crash; and
B) The “service membership list with associated birth-generation-IDs” received during re-registration in form of self-join event.

By comparing the above two “service membership list” at the time of processing the self-join event, it could identify the list of services that was added and the ones that had restarted in between. Based on this information it can generate another custom event for the services that had gone through membership changes to update the replicated state machine.

For example, consider the following members at some point in time with corresponding birth-gen-id stated as “b_gen_id.” The birth_gen_id tells us about the cluster generation ID at which the service joined CEM membership. It changes when the service goes down and resubscribes. Table A below shows that there are four services in the membership list, i.e., Aob_log_replay, DLM_1, DLM_2 and DLM_3 with birth_gen_ids=1,2,3,4 respectively.

TABLE A

Svc_members: {
(Aob_log_replay, b_gen_id: 1),
(DLM_1, b_gen_id: 2),
(DLM_2, b_gen_id: 3),
(DLM_3, b_gen_id: 4) }

This is the service membership list AoB_log_replay service saw in the last event it received from CEM, i.e., before it crashed and it was persisted by Aob_log_replay service as part of event processing. Later when it restarted after crash, as part of re-registration to CEM, it got a self-join event with the “service membership list” at that point in time. The membership list looked as follows in Table B below.

TABLE B

Svc_mem: {(DLM_1, gen_id: 2), ,
(DLM_3,b_gen_id: 4),
(DLM_4, b_gen_id: 5 )
(DLM_2, b_gen_id: 6),
Aob_log_replay, b_gen_id: 7}

By comparing the two lists, the posting service (e.g., Aob_log_replay) can figure out that DLM_2 restarted (changed b_gen_id) and DLM_4 is a new service added to the cluster. In other words, the posting service (e.g., Aob_log_replay) can deduce from the comparison of the service membership lists that during its absence from the cluster that second consuming service DLM_2 restarted because second consuming service is present in both membership lists, but has a different birth generation identifier. Specifically, the birth generation identifier in the earlier service membership list for second consuming service DLM_2 is 3 (see, e.g., Table A). The birth generation identifier in the later service membership list for second consuming service DLM_2 is 4 (see, e.g., Table B).

Similarly, the posting service (e.g., Aob_log_replay) can deduce from the comparison of the service membership lists that during its absence from the cluster that fourth consuming service DLM_4 is a new service that was added to the cluster because fourth consuming service DLM_4 was not present in the earlier service membership list (see, e.g., Table A), but is present in the later service membership list (see, e.g., Table B).

Based on the above calculation or deductions, a custom event can be posted by the posting service (e.g., AoB_log_replay service) to update the replicated state in DLM_3 and DLM_4 in this case.

More particularly, in this example, consider that at an initial time posting service 1008 (“AOB_log_replay”) and first, second, and third consuming services 1011A-C (“DLM_1-3”) are registered with CEM while fourth consuming service 1011D (“DLM_4”) is not registered with CEM. In other words, the first, second, and third consuming services are current members of the cluster and the fourth consuming service is not a current member of the cluster. There can be a scenario where a posting or sending service crashes and there are service membership changes in between.

In a step 1015, posting service (“AOB_log_replay”) posts a custom event to CEM. The custom event is accompanied by an event message number (e.g., Msg_num: X). In a step 1020, CEM queues the custom event for broadcast and retrieves a service membership list 1024 to include with broadcasting the custom event. Table C below shows the contents of the service membership list.

TABLE C

Svc_members: {
(Aob_log_replay, b_gen_id: 1),
(DLM_1, b_gen_id: 2),
(DLM_2, b_gen_id: 3),
(DLM_3, b_gen_id: 4) }

As shown in the example of Table C above, the services currently in the cluster include the posting service (“AOB_log_replay”) and first, second, and third consuming services (“DLM_1-3”). Posting service (“AOB_log_replay”) includes a birth generation identifier having a value 1. First consuming service (“DLM_1”) includes a birth generation identifier having a value 2. Second consuming service (“DLM_2”) includes a birth generation identifier having a value 3. Third consuming service (“DLM_3”) includes a birth generation identifier having a value 4.

In a step 1027, CEM delivers the custom event to each service in the cluster including posting service (“AOB_log_replay”).

In a step 1030, posting service (“AOB_log_replay”) receives the custom event with the service membership list and persists the information. The custom event is also received at each other service including first, second, and third consuming services (“DLM_1-3”).

In a step 1033, posting service (“AOB_log_replay”) crashes and is thus removed from the cluster. In a step 1036, second consuming service (“DLM_2”) crashes and is thus removed from the cluster. Meanwhile, the custom event continues to be processed on the remaining active members of the cluster, e.g., first and third consuming services (“DLM_1” and “DLM_3”, respectively).

In a step 1042, CEM receives a membership change event from the container orchestration service indicating that posting service (“AOB_log_replay”) and second consuming service (“DLM_2”) have left the cluster. CEM queues the membership change event for broadcast and generates, in response to the membership change event, a first updated service membership list 1024′. Table D below shows the contents of the first updated service membership list.

TABLE D

Svc_members: { (DLM_1, b_gen_id: 2),
(DLM_3, b_gen_id: 4) }

As shown in the example or Table D above, the services currently in the cluster include first consuming service (“DLM_1”) with a birth generation identifier having a value 2, and third consuming service (“DLM_3”) with a birth generation identifier having a value 4.

In a step 1045, CEM delivers the service down events associated with posting service (“AOB_log_replay”) and second consuming service (“DLM_2”) to each service presently in the cluster, e.g., first consuming service (“DLM_1”) and second consuming service (“DLM_2”).

In a step 1048, fourth consuming service (“DLM_4”) is added to the cluster and registers with CEM. In a step 1051, second consuming service (“DLM_2”) rejoins the cluster and registers with CEM.

In a step 1060, the membership change events including fourth consuming service (“DLM_4”) being added to the cluster and second consuming service (“DLM_2”) rejoining the cluster are received by CEM. CEM queues the membership change events for broadcast and generates, in response to the membership change events, a second updated service membership list 1024″. Table E below shows the contents of the second updated service membership list.

TABLE E

Svc_members: {
(DLM_1, b_gen_id: 2),
(DLM_3, b_gen_id: 4),
(DLM_4, b_gen_id: 5),
(DLM_2, b_gen_id: 6)
}

As shown in the example of Table E above, the services currently in the cluster include first consuming service (“DLM_1”) with a birth generation identifier having a value 2 and third consuming service (“DLM_3”) with a birth generation identifier having a value 4. Newly added fourth consuming service (“DLM_4”) with a birth generation identifier having a value 5 is also present in the membership list. Restarted second consuming service is also back in the membership list, but with a new birth generation identifier having a value 6.

In a step 1063, the membership change events about fourth and second consuming services having been added to the cluster are sent by CEM to the services in the cluster.

In a step 1066, posting service (“AOB_log_replay”) rejoins the cluster and registers with CEM.

In a step 1069, CEM receives a membership change event from the container orchestration service indicating that posting service (“AOB_log_replay”) has been added back to the cluster. CEM queues the add event for broadcast and generates, in response to the membership change event, a third updated service membership list 1024″ “′. Table F below shows the contents of the third updated service membership list.

TABLE F

Svc_members:
(DLM_1, b_gen_id: 2),
(DLM_3, b_gen_id: 4),
(DLM_4, b_gen_id: 5),
(DLM_2, b_gen_id: 6)
AoB_log_replay, b_gen id: 7}

As shown in the example of Table F above, the services currently in the cluster include first consuming service (“DLM_1″) with a birth generation identifier having a value 2, third consuming service (“DLM_3”) with a birth generation identifier having a value 4, fourth consuming service (“DLM_4”) with a birth generation identifier having a value 5, second consuming service (“DLM_2”) with a birth generation identifier having a value 6, and now posting service (“AOB_log_replay”) with a new birth generation identifier having a value 7.

In a step 1072, the membership change event about posting service (“AOB_log_replay”) having been added to the cluster are sent by CEM to the services in the cluster. As discussed, the event includes a latest copy of the service membership list (e.g., third updated service membership list) and is received by posting service (“AOB_log_replay”) because it is now an active member in the cluster and able to receive the event (and service membership list).

In a step 1075, posting service (“AOB_log_replay”) determines whether it has missed any events during its absence from the cluster. More particularly, posting service (“AOB_log_replay”) compares the previous service membership list persisted immediately before it crashed and left the cluster (e.g., service membership list 1024-Table C) with the most recently received service membership list (e.g., third updated service membership list 1024″. Table F). From the comparison of the membership lists, posting service (“AOB_log_replay”) can deduce that second consuming service (“DLM_2”) received the custom event, but crashed before completing processing of the custom event based on the different birth generation identifiers associated with second consuming service (“DLM_2”).

Posting service (“AOB_log_replay”) can also deduce that fourth consuming service (“DLM_4”) was added to the cluster after the custom event was broadcast based on fourth consuming service (“DLM_4”) being present in the latest or most recent third updated service membership list 1024″ “′, but absent in previous service membership list 1024.

Thus, in order to bring fourth consuming service (“DLM_4″) and second consuming service (“DLM_2”) to a consistent state with the other services (e.g., first and third consuming services (“DLM_1” and “DLM_3”), posting service (“AOB_log_replay”) in a step 1078 reposts the custom event with the same message number (e.g., Msg_num: X) as initially posted to CEM.

In an embodiment, any event received by a service is persisted with the member list included in the event. So, when a sender service leaves the membership, e.g., it dies, it may have persisted a service membership list X with respect to a last received event by the sender service. After the last received event by the sender service, other events including the sender service's own membership down event, may be broadcasted throughout the cluster. The sender service, however, may not receive such events because it is absent from the cluster.

Later, when the sender service re-joins the cluster, the cluster event manager broadcasts an event indicating the rejoin and includes a latest service membership list Y. The sender service itself thus also receives its self-join event with the latest service membership list Y. Now, by conducting a diff operation of service membership Y and service membership X, the sender service can figure out: 1) who joined; and 2) who left.

In a step 1085, CEM receives the reposted custom event from posting service (“AOB_log_replay”) with the same message number (e.g., Msg_num: X). CEM queues the event for broadcast and retrieves the most recent service membership list (e.g., third updated service membership list 1024″″) to include with the event broadcast.

In a step 1088, CEM delivers the reposted custom event to each service in the cluster. First and third consuming services (“DLM_1” and “DLM_3”), upon receipt of the event, can determine that they have already processed the event based on the event message number being the same as that processed earlier and thus ignore the event. Second and fourth consuming services (“DLM_2” and “DLM_4”), however, process the event because they do not have a record of having processed an event message having Msg_num: X. Thus, all services in the cluster are brought to a consistent state.

In an embodiment, a method includes: posting a first event to a cluster event manager for the cluster event manager to broadcast the first event to a plurality of services in a cluster, the first event being posted by a posting service of the plurality of services; receiving, from the cluster event manager, the first event and a service membership list listing each of the plurality of services that are currently in the cluster, each listed service in the service membership list including a name of a service and an identifier indicating when the service joined the cluster; persisting the first event including the service membership list, wherein after the persisting, the posting service leaves the cluster and then rejoins the cluster; upon rejoining the cluster, receiving, from the cluster event manager, a second event and an updated service membership list listing each of the plurality of services that are currently in the cluster, the service membership list now being a previous service membership list; deducing from a comparison of the updated service membership list and the previous service membership list that there is a particular service that was present in the cluster when the first event was broadcast, but left and rejoined the cluster when the posting service was absent from the cluster because the particular service is listed in both the updated service membership list and the previous service membership list, but the identifier indicating when the particular service joined the cluster as listed in the updated service membership list is different from the identifier indicating when the particular service joined the cluster as listed in the previous service membership list; and upon making the deduction, reposting the first event to the cluster event manager to broadcast the first event to the plurality of services in the cluster, the plurality of services including the particular service that left and rejoined the cluster.

In another embodiment, a method includes: posting a first event to a cluster event manager for the cluster event manager to broadcast the first event to a plurality of services in a cluster, the first event being posted by a posting service of the plurality of services; receiving, from the cluster event manager, the first event and a service membership list listing each of the plurality of services that are currently in the cluster; persisting the first event including the service membership list, wherein after the persisting, the posting service leaves the cluster and then rejoins the cluster; upon rejoining the cluster, receiving, from the cluster event manager, a second event and an updated service membership list listing each of the plurality of services that are currently in the cluster, the service membership list now being a previous service membership list; deducing from a comparison of the updated service membership list and the previous service membership list that there is a particular service that joined the cluster after the first event was broadcast and while the posting service was absent from the cluster because the particular service is not listed in the previous service membership list, but is listed in the updated service membership list; and upon making the deduction, reposting the first event to the cluster event manager to broadcast the first event to the plurality of services in the cluster, the plurality of services including the particular service that joined the cluster after the first event was initially broadcast and while the posting service was absent from the cluster, and wherein the reposted first event is assigned a message number by the posting service that is the same as a message number assigned to the first event when initially posted by the posting service.

In a specific embodiment, the cluster event manager sends an event, including custom events and membership change events, to all services that are registered with the cluster event manager. In another specific embodiment, the cluster event manager may send an event to only a subset of services that are registered with the cluster event manager. For example, during registration with the cluster event manager, a service may specify one or more types of messages it wishes to receive.

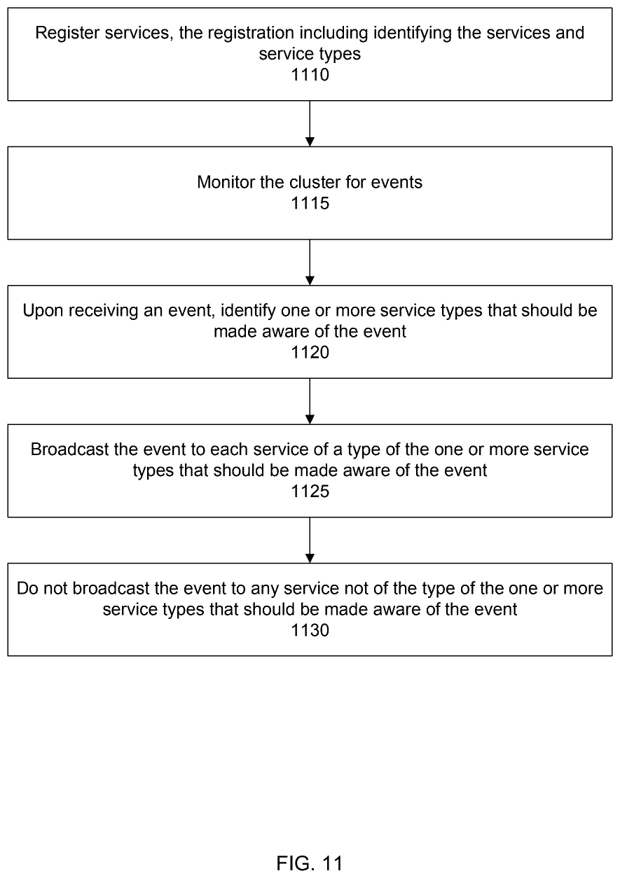

For example, FIG. 11 shows another embodiment of a broadcast flow. FIG. 11 is similar to the flow in FIG. 10, but in the flow of FIG. 11 an event is broadcast to only or at most a subset of services. Limiting the broadcast to specific services (or specific service types) can help to reduce network congestion. Specifically, in a step 1110, services belonging to the distributed application register with the cluster event manager. The registration includes identifying the services and service types associated with the services.

In a step 1115, the cluster is monitored for events.

In a step 1120, upon receiving an event, an identification is made of one or more service types that should be made aware of the event.

In a step 1125, the event is broadcast to each service of a type of the one or more service types that should be made aware of the event.

In a step 1130, the event is not broadcast to any service not of the type of the one or more service types that should be made aware of the event.

In an embodiment, a method includes: receiving a first event sent from a service belonging to a distributed data management application for one or more other services belonging to the application, the service and one or more other services being hosted across nodes of a cluster, and the service being a sending service; broadcasting, to each service in the cluster, the first event and a first membership list listing services that are currently members of the cluster; receiving a second event indicating that a new service belonging to the application has joined the cluster; and broadcasting, to each service in the cluster, the second event and a second membership list listing the services that are currently members of the cluster, the second membership list including the new service, wherein the sending service identifies the new service by comparing the first and second membership lists, and determines whether the new service should be sent the first event.

The method may include: receiving a third event indicating that a service belonging to the application has left the cluster; and broadcasting, to each service in the cluster, the third event and a third membership list listing the services that are currently members of the cluster, the third membership list not including the service that has left the cluster, wherein the sending service identifies the service that has left the cluster by comparing the second and third membership lists, and determines whether a lack of reply to the first event from the service that has left the cluster should be skipped.

The method may include: receiving a third event indicating that the sending service has left the cluster; receiving a fourth event indicating that the sending service has rejoined the cluster; and broadcasting, to each service in the cluster, the fourth event and a third membership list listing the services that are currently members of the cluster, wherein the sending service compares the third membership list against a membership list persisted before the sending service left the cluster to determine whether there were any membership changes during a time period when the sending service was absent from the cluster.

In an embodiment, after the broadcasting the first event, the sending service receives a reply responsive to the first event from a first service belonging to the application, does not receive the reply responsive to the first event from a second service belonging to the application, and waits for the reply from the second service, and the method further comprises: receiving a third event indicating that the second service has left the cluster; broadcasting, to each service in the cluster, the third event and a third membership list listing the services that are currently members of the cluster, the third membership list not including the second service, wherein the sending service compares the third membership list against a previous membership list and determines that the reply from the second service will not be coming because the second service is no longer a member of the cluster, and wherein the sending service, upon making the determination that the reply from the second service will not be coming, skips waiting for the reply from the second service.

The method may include: maintaining a queue comprising events sent from the services belonging to the application and events sent from a container orchestration service of the cluster, the container orchestration service being separate from the services belonging to the application.

In an embodiment, the sender service, upon determining that the new service should be sent the first event, reposts the first event for broadcast, and wherein the first event is reposted with a message number that is the same as a message number included with the first event when initially broadcasted.

In another embodiment, there is a system comprising: a processor; and memory configured to store one or more sequences of instructions which, when executed by the processor, cause the processor to carry out the steps of: receiving a first event sent from a service belonging to a distributed data management application for one or more other services belonging to the application, the service and one or more other services being hosted across nodes of a cluster, and the service being a sending service; broadcasting, to each service in the cluster, the first event and a first membership list listing services that are currently members of the cluster; receiving a second event indicating that a new service belonging to the application has joined the cluster; and broadcasting, to each service in the cluster, the second event and a second membership list listing the services that are currently members of the cluster, the second membership list including the new service, wherein the sending service identifies the new service by comparing the first and second membership lists, and determines whether the new service should be sent the first event.

In another embodiment, there is a computer program product, comprising a non-transitory computer-readable medium having a computer-readable program code embodied therein, the computer-readable program code adapted to be executed by one or more processors to implement a method comprising: receiving a first event sent from a service belonging to a distributed data management application for one or more other services belonging to the application, the service and one or more other services being hosted across nodes of a cluster, and the service being a sending service; broadcasting, to each service in the cluster, the first event and a first membership list listing services that are currently members of the cluster; receiving a second event indicating that a new service belonging to the application has joined the cluster; and broadcasting, to each service in the cluster, the second event and a second membership list listing the services that are currently members of the cluster, the second membership list including the new service, wherein the sending service identifies the new service by comparing the first and second membership lists, and determines whether the new service should be sent the first event.

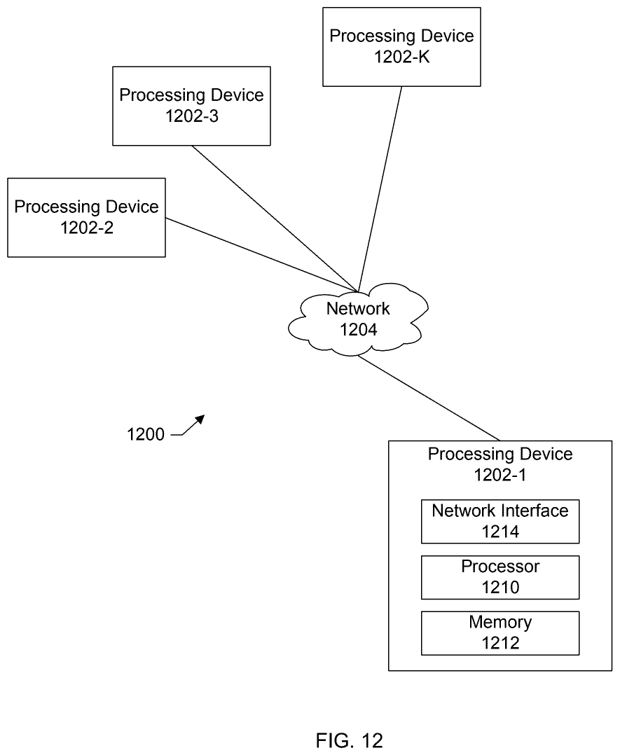

FIG. 12 shows an example of a processing platform 1200 that may include at least a portion of the information handling system shown in FIG. 1. The example shown in FIG. 12 includes a plurality of processing devices, denoted 1202-1, 1202-2, 1202-3, . . . 1202-K, which communicate with one another over a network 1204.

The network 1204 may comprise any type of network, including by way of example a global computer network such as the Internet, a WAN, a LAN, a satellite network, a telephone or cable network, a cellular network, a wireless network such as a WiFi or WiMAX network, or various portions or combinations of these and other types of networks.

The processing device 1202-1 in the processing platform 1200 comprises a processor 1210 coupled to a memory 1212.

The processor 1210 may comprise a microprocessor, a microcontroller, an application-specific integrated circuit (ASIC), a field-programmable gate array (FPGA) or other type of processing circuitry, as well as portions or combinations of such circuitry elements.

The memory 1212 may comprise random access memory (RAM), read-only memory (ROM) or other types of memory, in any combination. The memory 1212 and other memories disclosed herein should be viewed as illustrative examples of what are more generally referred to as “processor-readable storage media” storing executable program code of one or more software programs.

Articles of manufacture comprising such processor-readable storage media are considered illustrative embodiments. A given such article of manufacture may comprise, for example, a storage array, a storage disk or an integrated circuit containing RAM, ROM or other electronic memory, or any of a wide variety of other types of computer program products. The term “article of manufacture” as used herein should be understood to exclude transitory, propagating signals. Numerous other types of computer program products comprising processor-readable storage media can be used.

Also included in the processing device 1202-1 is network interface circuitry 1214, which is used to interface the processing device with the network 1204 and other system components, and may comprise conventional transceivers.

The other processing devices 1202 of the processing platform 1200 are assumed to be configured in a manner similar to that shown for processing device 1202-1 in the figure.

Again, the particular processing platform 1200 shown in the figure is presented by way of example only, and the information handling system may include additional or alternative processing platforms, as well as numerous distinct processing platforms in any combination, with each such platform comprising one or more computers, servers, storage devices or other processing devices.

For example, other processing platforms used to implement illustrative embodiments can comprise different types of virtualization infrastructure, in place of or in addition to virtualization infrastructure comprising virtual machines. Such virtualization infrastructure illustratively includes container-based virtualization infrastructure configured to provide Docker containers or other types of LXCs.

As another example, portions of a given processing platform in some embodiments can comprise converged infrastructure such as VxRail™, VxRack™, VxRack™ FLEX, VxBlock™, or Vblock® converged infrastructure from VCE, the Virtual Computing Environment Company, now the Converged Platform and Solutions Division of Dell EMC.

It should therefore be understood that in other embodiments different arrangements of additional or alternative elements may be used. At least a subset of these elements may be collectively implemented on a common processing platform, or each such element may be implemented on a separate processing platform.

Also, numerous other arrangements of computers, servers, storage devices or other components are possible in the information processing system. Such components can communicate with other elements of the information processing system over any type of network or other communication media.

As indicated previously, components of an information processing system as disclosed herein can be implemented at least in part in the form of one or more software programs stored in memory and executed by a processor of a processing device. For example, at least portions of the functionality of one or more components of the compute services platform 100 are illustratively implemented in the form of software running on one or more processing devices.

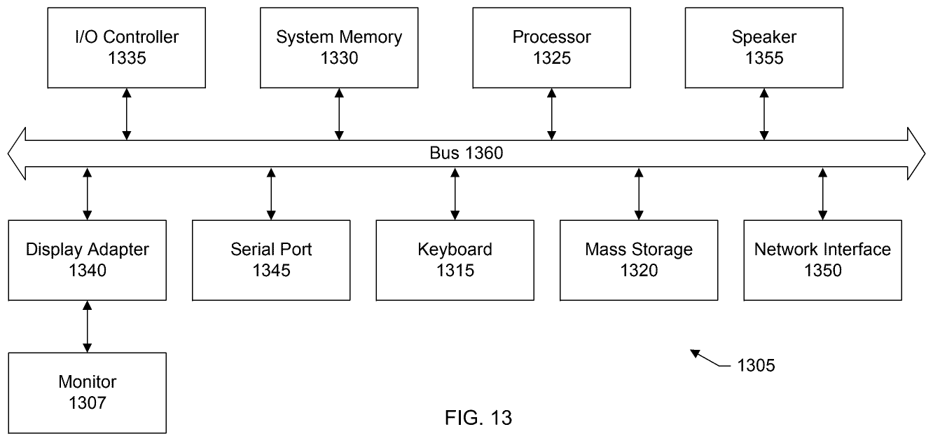

FIG. 13 shows a system block diagram of a computer system 1305 used to execute the software of the present system described herein. The computer system includes a monitor 1307, keyboard 1315, and mass storage devices 1320. Computer system 1305 further includes subsystems such as central processor 1325, system memory 1330, input/output (I/O) controller 1335, display adapter 1340, serial or universal serial bus (USB) port 1345, network interface 1350, and speaker 1355. The system may also be used with computer systems with additional or fewer subsystems. For example, a computer system could include more than one processor 1325 (i.e., a multiprocessor system) or a system may include a cache memory.

Arrows such as 1360 represent the system bus architecture of computer system 1305. However, these arrows are illustrative of any interconnection scheme serving to link the subsystems. For example, speaker 1355 could be connected to the other subsystems through a port or have an internal direct connection to central processor 1325. The processor may include multiple processors or a multicore processor, which may permit parallel processing of information. Computer system 1305 shown in FIG. 13 is but an example of a computer system suitable for use with the present system. Other configurations of subsystems suitable for use with the present invention will be readily apparent to one of ordinary skill in the art.

Computer software products may be written in any of various suitable programming languages. The computer software product may be an independent application with data input and data display modules. Alternatively, the computer software products may be classes that may be instantiated as distributed objects. The computer software products may also be component software.

An operating system for the system may be one of the Microsoft Windows®, family of systems (e.g., Windows Server), Linux, Mac OS X, IRIX32, or IRIX64. Other operating systems may be used. Microsoft Windows is a trademark of Microsoft Corporation.

Furthermore, the computer may be connected to a network and may interface to other computers using this network. The network may be an intranet, internet, or the Internet, among others. The network may be a wired network (e.g., using copper), telephone network, packet network, an optical network (e.g., using optical fiber), or a wireless network, or any combination of these. For example, data and other information may be passed between the computer and components (or steps) of a system of the invention using a wireless network using a protocol such as Wi-Fi (IEEE standards 802.11, 802.11a, 802.11b, 802.11e, 802.11 g, 802.11i, 802.11n, 802.11ac, and 802.11ad, just to name a few examples), near field communication (NFC), radio-frequency identification (RFID), mobile or cellular wireless. For example, signals from a computer may be transferred, at least in part, wirelessly to components or other computers.

In the description above and throughout, numerous specific details are set forth in order to provide a thorough understanding of an embodiment of this disclosure. It will be evident, however, to one of ordinary skill in the art, that an embodiment may be practiced without these specific details. In other instances, well-known structures and devices are shown in block diagram form to facilitate explanation. The description of the preferred embodiments is not intended to limit the scope of the claims appended hereto. Further, in the methods disclosed herein, various steps are disclosed illustrating some of the functions of an embodiment. These steps are merely examples, and are not meant to be limiting in any way. Other steps and functions may be contemplated without departing from this disclosure or the scope of an embodiment. Other embodiments include systems and non-volatile media products that execute, embody or store processes that implement the methods described above.

What is claimed is:

1. A method comprising:
receiving a first event sent from a service belonging to a distributed data management application for one or more other services belonging to the application, the service and one or more other services being hosted across nodes of a cluster, and the service being a sending service;
broadcasting, to each service in the cluster, the first event and a first membership list listing services that are currently members of the cluster;
receiving a second event indicating that a new service belonging to the application has joined the cluster; and
broadcasting, to each service in the cluster, the second event and a second membership list listing the services that are currently members of the cluster, the second membership list including the new service, wherein the sending service identifies the new service by comparing the first and second membership lists, and determines whether the new service should be sent the first event.

2. The method of claim 1 further comprising:
receiving a third event indicating that a service belonging to the application has left the cluster; and
broadcasting, to each service in the cluster, the third event and a third membership list listing the services that are currently members of the cluster, the third membership list not including the service that has left the cluster, wherein the sending service identifies the service that has left the cluster by comparing the second and third membership lists, and determines whether a lack of reply to the first event from the service that has left the cluster should be skipped.

3. The method of claim 1 further comprising:
receiving a third event indicating that the sending service has left the cluster;
receiving a fourth event indicating that the sending service has rejoined the cluster; and
broadcasting, to each service in the cluster, the fourth event and a third membership list listing the services that are currently members of the cluster, wherein the sending service compares the third membership list against a membership list persisted before the sending service left the cluster to determine whether there were any membership changes during a time period when the sending service was absent from the cluster.

4. The method of claim 1 wherein after the broadcasting the first event, the sending service receives a reply responsive to the first event from a first service belonging to the application, does not receive the reply responsive to the first event from a second service belonging to the application, and waits for the reply from the second service, and the method further comprises:
receiving a third event indicating that the second service has left the cluster;
broadcasting, to each service in the cluster, the third event and a third membership list listing the services that are currently members of the cluster, the third membership list not including the second service, wherein the sending service compares the third membership list against a previous membership list and determines that the reply from the second service will not be coming because the second service is no longer a member of the cluster, and
wherein the sending service, upon making the determination that the reply from the second service will not be coming, skips waiting for the reply from the second service.

5. The method of claim 1 further comprising:
maintaining a queue comprising events sent from the services belonging to the application and events sent from a container orchestration service of the cluster, the container orchestration service being separate from the services belonging to the application.

6. The method of claim 1 wherein the sender service, upon determining that the new service should be sent the first event, reposts the first event for broadcast, and wherein the first event is reposted with a message number that is the same as a message number included with the first event when initially broadcasted.

7. A system comprising: a processor; and memory configured to store one or more sequences of instructions which, when executed by the processor, cause the processor to carry out the steps of:
receiving a first event sent from a service belonging to a distributed data management application for one or more other services belonging to the application, the service and one or more other services being hosted across nodes of a cluster, and the service being a sending service;
broadcasting, to each service in the cluster, the first event and a first membership list listing services that are currently members of the cluster;
receiving a second event indicating that a new service belonging to the application has joined the cluster; and
broadcasting, to each service in the cluster, the second event and a second membership list listing the services that are currently members of the cluster, the second membership list including the new service, wherein the sending service identifies the new service by comparing the first and second membership lists, and determines whether the new service should be sent the first event.

8. The system of claim 7 wherein the processor further carries out the steps of:
receiving a third event indicating that a service belonging to the application has left the cluster; and
broadcasting, to each service in the cluster, the third event and a third membership list listing the services that are currently members of the cluster, the third membership list not including the service that has left the cluster, wherein the sending service identifies the service that has left the cluster by comparing the second and third membership lists, and determines whether a lack of reply to the first event from the service that has left the cluster should be skipped.

9. The system of claim 7 wherein the processor further carries out the steps of:
receiving a third event indicating that the sending service has left the cluster;
receiving a fourth event indicating that the sending service has rejoined the cluster; and
broadcasting, to each service in the cluster, the fourth event and a third membership list listing the services that are currently members of the cluster, wherein the sending service compares the third membership list against a membership list persisted before the sending service left the cluster to determine whether there were any membership changes during a time period when the sending service was absent from the cluster.

10. The system of claim 7 wherein after the broadcasting the first event, the sending service receives a reply responsive to the first event from a first service belonging to the application, does not receive the reply responsive to the first event from a second service belonging to the application, and waits for the reply from the second service, and the processor further carries out the steps of:
receiving a third event indicating that the second service has left the cluster;
broadcasting, to each service in the cluster, the third event and a third membership list listing the services that are currently members of the cluster, the third membership list not including the second service, wherein the sending service compares the third membership list against a previous membership list and determines that the reply from the second service will not be coming because the second service is no longer a member of the cluster, and
wherein the sending service, upon making the determination that the reply from the second service will not be coming, skips waiting for the reply from the second service.

11. The system of claim 7 wherein the processor further carries out the steps of:
maintaining a queue comprising events sent from the services belonging to the application and events sent from a container orchestration service of the cluster, the container orchestration service being separate from the services belonging to the application.

12. The system of claim 7 wherein the sender service, upon determining that the new service should be sent the first event, reposts the first event for broadcast, and wherein the first event is reposted with a message number that is the same as a message number included with the first event when initially broadcasted.

13. A computer program product, comprising a non-transitory computer-readable medium having a computer-readable program code embodied therein, the computer-readable program code adapted to be executed by one or more processors to implement a method comprising:
receiving a first event sent from a service belonging to a distributed data management application for one or more other services belonging to the application, the service and one or more other services being hosted across nodes of a cluster, and the service being a sending service;
broadcasting, to each service in the cluster, the first event and a first membership list listing services that are currently members of the cluster;
receiving a second event indicating that a new service belonging to the application has joined the cluster; and
broadcasting, to each service in the cluster, the second event and a second membership list listing the services that are currently members of the cluster, the second membership list including the new service, wherein the sending service identifies the new service by comparing the first and second membership lists, and determines whether the new service should be sent the first event.

14. The computer program product of claim 13 wherein the method further comprises:
receiving a third event indicating that a service belonging to the application has left the cluster; and
broadcasting, to each service in the cluster, the third event and a third membership list listing the services that are currently members of the cluster, the third membership list not including the service that has left the cluster, wherein the sending service identifies the service that has left the cluster by comparing the second and third membership lists, and determines whether a lack of reply to the first event from the service that has left the cluster should be skipped.

15. The computer program product of claim 13 wherein the method further comprises:
receiving a third event indicating that the sending service has left the cluster;
receiving a fourth event indicating that the sending service has rejoined the cluster; and
broadcasting, to each service in the cluster, the fourth event and a third membership list listing the services that are currently members of the cluster, wherein the sending service compares the third membership list against a membership list persisted before the sending service left the cluster to determine whether there were any membership changes during a time period when the sending service was absent from the cluster.

16. The computer program product of claim 1 wherein after the broadcasting the first event, the sending service receives a reply responsive to the first event from a first service belonging to the application, does not receive the reply responsive to the first event from a second service belonging to the application, and waits for the reply from the second service, and the method further comprises:
receiving a third event indicating that the second service has left the cluster;
broadcasting, to each service in the cluster, the third event and a third membership list listing the services that are currently members of the cluster, the third membership list not including the second service, wherein the sending service compares the third membership list against a previous membership list and determines that the reply from the second service will not be coming because the second service is no longer a member of the cluster, and
wherein the sending service, upon making the determination that the reply from the second service will not be coming, skips waiting for the reply from the second service.

17. The computer program product of claim 13 wherein the method further comprises:
maintaining a queue comprising events sent from the services belonging to the application and events sent from a container orchestration service of the cluster, the container orchestration service being separate from the services belonging to the application.

18. The computer program product of claim 13 wherein the sender service, upon determining that the new service should be sent the first event, reposts the first event for broadcast, and wherein the first event is reposted with a message number that is the same as a message number included with the first event when initially broadcasted.
